(19) United States
(12) Patent Application Publication
(10) Pub. No.: US 2026/0257340 A1
(43) Pub. Date: Sep. 3, 2026

(54) TEACHING METHOD AND DEVICE FOR COLLABORATIVE ROBOTS

(71) Applicant: CDR SYSTEM CO., LTD., Hwaseong-si (KR)

(72) Inventor: Ki Tak AHN, Hwaseong-si (KR)

(21) Appl. No.: 18/871,445

(22) PCT Filed: May 22, 2023
(86) PCT No.: PCT/KR2023/006921

§ 371 Date: Dec. 3, 2024

(30) Foreign Application Priority Data
Jun. 20, 2022 (KR) 10-2022-0075023

(51) Int. Cl. B25J 9/00; B25J 9/06; B25J 9/16

(52) U.S. Cl. CPC B25J 9/0081; B25J 9/06; B25J 9/1638; B25J 9/1653

(57) ABSTRACT

Provided are a teaching method and teaching device for collaborative robots. The teaching device is installed and fixed to a reference installation position and obtains a first reference teaching point from a first 6-axis robot having an end effector positioned at a reference point. The teaching device is replaced with the first 6-axis robot and is installed and fixed to substantially the same position as the reference installation position and obtains a second reference teaching point from a second 6-axis robot having an end effector positioned at the reference point. The teaching device calculates, on the basis of a difference between the first reference teaching point and the second reference teaching point, a plurality of second teaching points for the second 6-axis robot from a plurality of first teaching points.

### TECHNICAL FIELD

The present disclosure relates to robot teaching, and more particularly to teaching methods and devices for collaborative robots.

### BACKGROUND ART

Collaborative robots are robots that typically work alongside humans, meaning they are designed and used to interact with humans. While industrial robots perform tasks on behalf of humans in a workspace separate from humans, collaborative robots complement humans, working alongside them to increase their efficiency.

In order to utilize a robot, a user needs to implement the user's work intention in a form that the robot can understand through various means, which is called teaching the robot. Traditionally, there are two ways of teaching: the user writes a teaching program by hand or uses a teaching pendant to input teaching points. The direct teaching method, which is often used in recent years, allows the user to directly access the robot by holding a robot's end effector and store teaching points by pushing or pulling the robot's end effector, which is particularly suitable for collaborative robots.

Robots in service may be replaced for various reasons, such as maintenance or failure. Each time a robot is replaced, a new teaching task must be completed and it is usually costly and time-consuming to manually record hundreds of new teaching points.

### DISCLOSURE

### Technical Problem

The present disclosure provides a teaching method and apparatus for a six-axis collaborative robot.

### Technical Solution

In an aspect, a method for teaching a collaborative robot is provided. The method includes obtaining a first reference teaching point from a first six-axis robot which is fixedly installed at a reference installation position, an end effector of the first six-axis robot being located at a reference point, obtaining a second reference teaching point from a second six-axis robot which is replaced with the first six-axis robot and is fixedly installed in substantially the same position as the reference installation position, an end effector of the second six-axis robot being located at the reference point, obtaining a plurality of first teaching points at which the first six-axis robot performs one or more tasks, and calculating a plurality of second teaching points for the second six-axis robot from the plurality of first teaching points based on a difference between the first reference teaching point and the second reference teaching point.

In another aspect, a device for teaching a collaborative robot includes a communication unit configured to communicate with a controller of a first six-axis robot or a second six-axis robot, a processor coupled with the communication unit, and a memory operatively coupled with the processor and configured to store instructions that, when executed by the processor, cause the device to perform functions, The functions include obtaining a first reference teaching point from the first six-axis robot which is fixedly installed at a reference installation position, an end effector of the first six-axis robot being located at a reference point, obtaining a second reference teaching point from the second six-axis robot which is replaced with the first six-axis robot and is fixedly installed in substantially the same position as the reference installation position, an end effector of the second six-axis robot being located at the reference point, obtaining a plurality of first teaching points at which the first six-axis robot performs one or more tasks, and calculating a plurality of second teaching points for the second six-axis robot from the plurality of first teaching points based on a difference between the first reference teaching point and the second reference teaching point.

In still another aspect, a non-transitory computer-readable medium having computer-executable instructions tangibly embodied thereon that when executed by a processor, cause a teaching device to obtain a first reference teaching point from a first six-axis robot which is fixedly installed at a reference installation position, an end effector of the first six-axis robot being located at a reference point, obtain a second reference teaching point from a second six-axis robot which is replaced with the first six-axis robot and is fixedly installed in substantially the same position as the reference installation position, an end effector of the second six-axis robot being located at the reference point, obtain a plurality of first teaching points at which the first six-axis robot performs one or more tasks, and calculate a plurality of second teaching points for the second six-axis robot from the plurality of first teaching points based on a difference between the first reference teaching point and the second reference teaching point.

### Advantageous Effects

Even if the collaborative robot you're using is replaced by a new one, you can drastically reduce the time it takes to perform new teaching tasks.

### DESCRIPTION OF DRAWINGS

FIG. 1 illustrates a robotic system according to an embodiment of the present disclosure.

FIG. 2 illustrates an end effector according to an embodiment of the present disclosure.

FIG. 3 shows a fixed coupling module according to an embodiment of the present disclosure.

FIG. 4 illustrates an interaction between the end effector and the fixed coupling module.

FIG. 5 illustrates a teaching method according to an embodiment of the present disclosure.

### MODE FOR DISCLOSURE

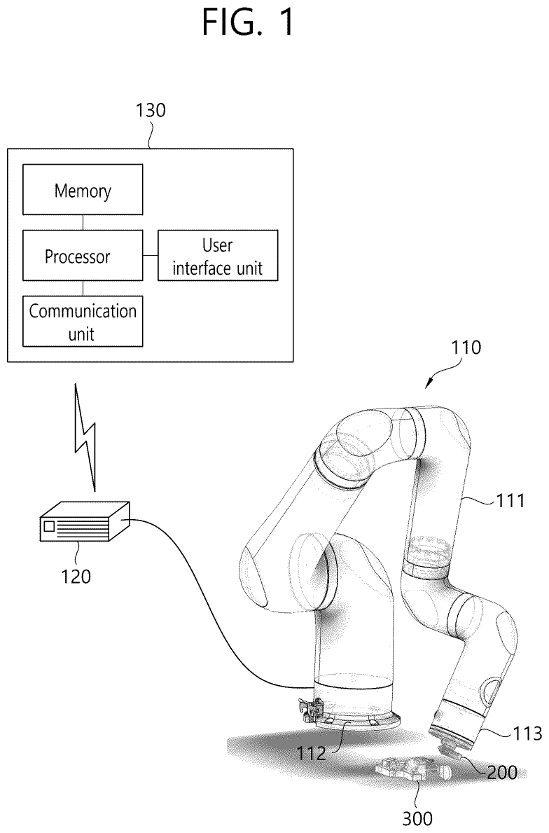

FIG. 1 illustrates a robotic system according to an embodiment of the present disclosure.

A robot system can include a collaborative robot 110, a robot controller 120, and a teaching device 130. The collaborative robot 110 may include a six-axis robotic arm. The number of axes of the collaborative robot 110 or the type of robot is for illustrative purposes only.

The collaborative robot 110 can include a body 111 that provides the shape of the robot, a robot base 112 for securing the body 111 to a reference installation position on a frame, and an end mount 113 where an end effector 200 is mounted. The end effector 200 is a device designed to allow the collaborative robot 110 to interact with its surroundings to perform a task.

The robot controller 120 is responsible for controlling the behavior of the collaborative robot 110. The robot controller 120 can store teaching points and control the movement of the six-axis collaborative robot 110 along the teaching points for one or more tasks.

A teaching device 130 may be wired and/or wirelessly connected to the robot controller 120 to perform teaching tasks according to the proposed embodiment.

The teaching device 130 can include a processor 131, a memory 132, a communication unit 133, and a user interface unit 134. The processor 131 can implement functions related to a teaching method according to the proposed embodiment. The memory 132 can store instructions executed by the processor 131 and various information. The memory 132 can include any form of computer-readable medium operable to store information. For example, the memory 132 may include read only memory (ROM), random access memory (RAM), digital video disc (DVD), optical disc, flash memory, solid state drive (SSD), hard drive, and combinations thereof. The communication unit 133 can provide a wired communication protocol and/or a wireless communication protocol for communicating with the robot controller 120. The processor 131 can exchange various information with the robot controller 120 via the communication unit 133. The user interface unit 134 can provide various interfaces to a user for teaching tasks.

The end mount 113 of the collaborative robot 110 is equipped with the end effector 200. While operating in teaching, the end effector 200 may include a coupling device for setting up a reference teaching point. At a certain location on the frame disposed around the collaborative robot 110, a fixed coupling module 300 can be mounted. The end effector 200 can be inserted into the fixed coupling module 300 so that the end effector 200 of the collaborative robot 110 is positioned at the reference point. The end effector 200 and the fixed coupling module 300 may be referred to as a reference setting module.

The collaborative robot 110 may be a six-degrees-of-freedom robotic arm having six axes of rotation (or six joints). If an end of the six-degree-of-freedom collaborative robot is constrained, all other joints are also constrained and the six-degree-of-freedom collaborative robot cannot move. When the six axis positions (X, Y, Z, u(roll), v(pitch), w(yaw)) (i.e., the three Cartesian coordinates and their orientations) of the end of the six-degree-of-freedom collaborative robot are determined, the six joint angles (θ1, θ2, θ3, θ4, θ5, θ6) are determined. One teaching point may include six joint angles. When the six-axis collaborative robot 110 is positioned at the reference point, this position becomes a reference teaching point (also referred to as a master teaching point or a reference calibration point).

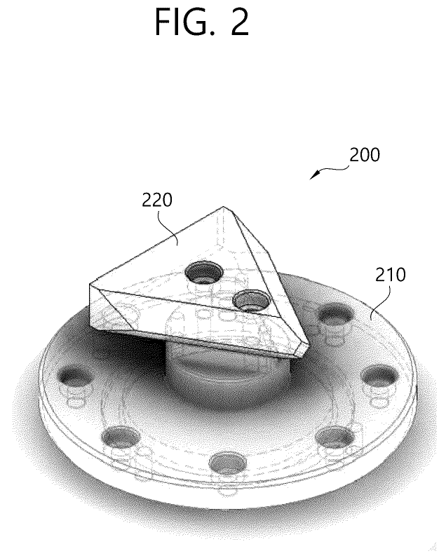

FIG. 2 illustrates an end effector according to an embodiment of the present disclosure.

The end effector 200 includes a flange unit 210 and a male coupling unit 220. The flange unit 210 is connected to the end mounting portion 113 of the collaborative robot 110 and is used to secure the end effector 200 to the collaborative robot 110. The male coupling unit 220 is a unit that is coupled to the fixed coupling module 300 and may have a triangular shape. The shape of the male coupling unit 220 is illustrative only, and may have at least a two-sided shape.

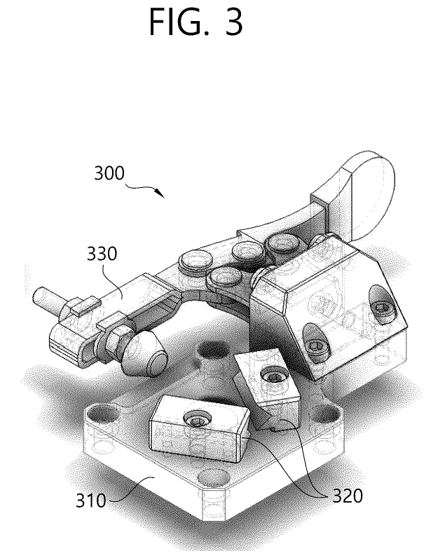

FIG. 3 shows a fixed coupling module according to an embodiment of the present disclosure.

The fixed coupling module 300 can include a fixture 310, a female coupling unit 320, and a fixing clamp 330. The fixture 310 is fixed to the frame to secure the fixed coupling module 300. The male coupling unit 220 of the end effector 200 can be inserted into the female coupling unit 320. The fixing clamp 330 is used to securely hold the male coupling unit 220 after the male coupling unit 220 enters into the female coupling unit 320.

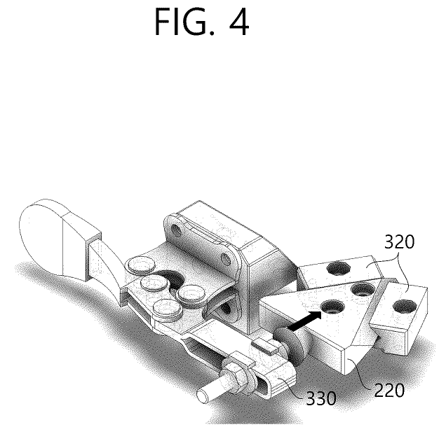

FIG. 4 illustrates an interaction between the end effector and the fixed coupling module.

The collaborative robot is moved to press the male coupling unit 220 into the female coupling unit 320. The two sides of the male coupling unit 220 can be pressed against the inside of the female coupling unit 320. Then the user can operate the lever of the fixing clamp 330 to push the remaining one side of the male coupling unit 220, so that the male coupling unit 220 is fully secured to the female coupling unit 320.

When the end effector 200 is securely fastened to the fixed coupling module 300, its position of the end effector 200 becomes a reference point, and a teaching point obtained from the reference point becomes a reference teaching point.

Here, a user manually secures the end effector to the fixed coupling module, but the end effector may also be secured to the fixed coupling module by an automated method.

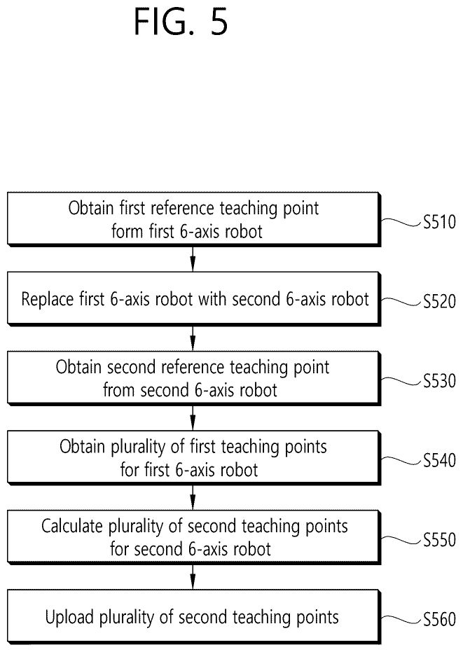

FIG. 5 illustrates a teaching method according to an embodiment of the present disclosure. The method may be performed by a teaching device. The first six-axis robot and the second six-axis robot may both be collaborative robots.

In step S510, the teaching device obtains a first reference teaching point from the first six-axis robot. The first six-axis robot can fixedly be installed at the reference installation position. The teaching device can wired or wirelessly be connected to a controller of the first 6-axis robot. An end effector of the first 6-axis robot is installed for setting the reference point.

The first six-axis robot can enter in direct teaching mode by using the teaching device. In the direct teaching mode, the user can directly move the six-axis robot to the desired point. The six-axis robot can be operated in the direct teaching mode in which a user directly manipulates the six-axis robot in a gravity compensated control state to move to a specific point.

In the direct teaching mode, the user can fix the end effector of the first 6-axis robot at a reference point and store the reference point as a first reference teaching point.

The user can then change the end effector used to teach the first reference teaching point into a new end effector used to teach teaching points for one or more tasks. The set of teaching points of the first six-axis robot is referred to as a set of first teaching points.

In step S520, the first six-axis robot is replaced with a second six-axis robot. Any six-axis robot may be replaced for various reasons such as periodic inspection or maintenance. Here, “replace” refers to when a new teaching task is required, such as when the first six-axis robot is replaced with a new six-axis robot, or when a failed first 6-axis robot is repaired and reinstalled (the first 6-axis robot and the second 6-axis robot are identical).

The new six-axis robot can be installed at the same location because the new six-axis robot performs the same tasks as the replaced six-axis robot. The second six-axis robot can be installed at substantially the same location as the reference installation location of the first six-axis robot. “Substantially the same location” means the same location considering an installation error of the robot.

In step S530, the teaching device obtains a second reference teaching point from the second six-axis robot. The second six-axis robot can fixedly be installed in the same reference installation position. The teaching device can wired or wirelessly be connected to the controller of the second six-axis robot. An end effector of the second six-axis robot can be installed for setting a reference point. In the direct teaching mode, the user can fix the end effector of the second six-axis robot to the reference point and store the reference point as a second reference teaching point.

In step S540, the teaching device obtains a plurality of first teaching points for the first 6-axis robot. The plurality of first teaching points may be stored in the teaching device in advance. Since the controller can typically not be replaced even if the robot is replaced, the teaching device can download the plurality of first teaching points from the current robot controller.

In step S550, the teaching device calculates a plurality of second teaching points for the second six-axis robot. The teaching device can calculate the plurality of second teaching points for the second six-axis robot from the plurality of first teaching points based on a difference between the first reference teaching point and the second reference teaching point.

For example, assume that the six-axis absolute position of the first reference teaching point is (X, Y, Z, u, v, w)=(0.5949998757013094, −0.1970000102274096, 0.19999900481931313, 86.64625586020759, −88.64989631276185, 91.54368898903233), and the six-axis joint angles have (−0.5213966054365012, −56.30225315567262, −123.93522404442965, 1.287630288907882, 90.31664555616312, 178.65760123376796).

Assume that the six-axis absolute position of the second reference teaching point (X, Y, Z, u, v, w)=(0.5949998757013094, −0.1970000102274096, 0.19999900481931313, 86.64625586020759, −88.64989631276185, 91.54368898903233) and the 6-axis joint angles have (−0.521351207386398, −56.30229855372272, −123.93526944247975, 1.287684676670877, 90.31659116840012, 178.65771000929394).

The six-axis joint angles of the second reference teaching point−the 6-axis joint angles of the first reference teaching point is (−4.539805010328468e−05, 4.5398050104950016e−05, 4.5398050104950016e−05, −5.438776299504511e−05, 5.438776300081827e−05, −0.00010877552597321483). By applying this difference value (or may be called as offset) to a plurality of first teaching points, a plurality of second teaching points can be calculated. For example, the second teaching point=first teaching point+difference value.

In step S560, the teaching device uploads the calculated plurality of second teaching points to the controller of the second six-axis robot. Accordingly, the second six-axis robot can perform tasks based on the second teaching points without requiring additional teaching operations.

In general, when a robot is replaced, it is necessary to reteach the entire robot system due to various installation errors (e.g., errors due to the reference installation position, assembly errors of the robot, assembly errors of the end effector, etc.). In the case of a collaborative robot, the repetition accuracy for repeating a predetermined position is more important to perform a task than the absolute positioning accuracy. Therefore, updating the teaching points based on the new reference teaching point and the existing reference teaching point may facilitate the new collaborative robot to perform the task.

Furthermore, while embodiments of the present disclosure illustrate a single reference point, it is possible to establish a plurality of reference points. The plurality of reference points can be obtained by placing a plurality of fixed coupling modules at a plurality of locations. Based on the plurality of reference points, a plurality of reference teaching points can be obtained. After the robot is replaced, differences between the plurality of reference teaching points can be obtained and new teaching points can be calculated based on the differences. For example, the new teaching points may be calculated by applying an average value of the differences to the old teaching points.

In the exemplary systems described above, the methods are described based on flowcharts as a series of steps or blocks, but the present disclosure is not limited to the order of the steps, and some steps may occur in a different order or simultaneously with other steps as described above. Further, those skilled in the art will understand that the steps shown in the flowcharts are not exclusive and that other steps may be included or one or more steps in the flowcharts may be deleted without affecting the scope of the disclosure.

1. A method for teaching a collaborative robot, the method comprising:
obtaining a first reference teaching point from a first six-axis robot which is fixedly installed at a reference installation position, an end effector of the first six-axis robot being located at a reference point;
obtaining a second reference teaching point from a second six-axis robot which is replaced with the first six-axis robot and is fixedly installed in substantially the same position as the reference installation position, an end effector of the second six-axis robot being located at the reference point;
obtaining a plurality of first teaching points at which the first six-axis robot performs one or more tasks; and
calculating a plurality of second teaching points for the second six-axis robot from the plurality of first teaching points based on a difference between the first reference teaching point and the second reference teaching point.

2. The method of claim 1, wherein the first 6-axis robot or the second 6-axis robot is operated in a direct teaching mode in which a user directly manipulates a corresponding six-axis robot in a gravity compensated control state to move to the reference point while the end effector of a corresponding six-axis robot is moved to the reference point.

3. The method of claim 1, wherein the first reference teaching point, the second reference teaching point and each of the plurality of first teaching points include information regarding six joint angles for a corresponding six-axis robot.

4. A device for teaching a collaborative robot, the device comprising:
a communication unit configured to communicate with a controller of a first six-axis robot or a second six-axis robot;
a processor coupled with the communication unit; and
a memory operatively coupled with the processor and configured to store instructions that, when executed by the processor, cause the device to perform functions comprising:
obtaining a first reference teaching point from the first six-axis robot which is fixedly installed at a reference installation position, an end effector of the first six-axis robot being located at a reference point;
obtaining a second reference teaching point from the second six-axis robot which is replaced with the first six-axis robot and is fixedly installed in substantially the same position as the reference installation position, an end effector of the second six-axis robot being located at the reference point;
obtaining a plurality of first teaching points at which the first six-axis robot performs one or more tasks; and
calculating a plurality of second teaching points for the second six-axis robot from the plurality of first teaching points based on a difference between the first reference teaching point and the second reference teaching point.

5. The device of claim 4, wherein the first 6-axis robot or the second 6-axis robot is operated in a direct teaching mode in which a user directly manipulates a corresponding six-axis robot in a gravity compensated control state to move to the reference point while the end effector of a corresponding six-axis robot is moved to the reference point.

6. The device of claim 4, wherein the first reference teaching point, the second reference teaching point and each of the plurality of first teaching points include information regarding six joint angles for a corresponding six-axis robot.

7. A non-transitory computer-readable medium having computer-executable instructions tangibly embodied thereon that when executed by a processor, cause a teaching device to:
obtain a first reference teaching point from a first six-axis robot which is fixedly installed at a reference installation position, an end effector of the first six-axis robot being located at a reference point;
obtain a second reference teaching point from a second six-axis robot which is replaced with the first six-axis robot and is fixedly installed in substantially the same position as the reference installation position, an end effector of the second six-axis robot being located at the reference point;
obtain a plurality of first teaching points at which the first six-axis robot performs one or more tasks; and
calculate a plurality of second teaching points for the second six-axis robot from the plurality of first teaching points based on a difference between the first reference teaching point and the second reference teaching point.

8. The non-transitory computer-readable medium of claim 7, wherein the first 6-axis robot or the second 6-axis robot is operated in a direct teaching mode in which a user directly manipulates a corresponding six-axis robot in a gravity compensated control state to move to the reference point while the end effector of a corresponding six-axis robot is moved to the reference point.

9. The non-transitory computer-readable medium of claim 7, wherein the first reference teaching point, the second reference teaching point and each of the plurality of first teaching points include information regarding six joint angles for a corresponding six-axis robot.
